(19) United States
(12) Patent Application Publication
(10) Pub. No.: US 2003/0038876 A1
(43) Pub. Date: Feb. 27, 2003

(54) Digital camera having a display on which diving information is indicated

(75) Inventor: Akio Nagashima, Saitama (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/226,128

(22) Filed: Aug. 23, 2002

(30) Foreign Application Priority Data
Aug. 24, 2001 (JP) 2001-253833
Jul. 1, 2002 (JP) 2002-192322

(51) Int. Cl. H04N 7/18; H04N 9/47

(52) U.S. Cl. 348/81

(57) ABSTRACT

A digital camera having water proofing property is provided with a pressure sensor and a temperature sensor. A diving-information processor obtains various items of diving information on the basis of detection results of the pressure sensor and the temperature sensor. The diving information includes a diving depth, a water temperature, a maximum depth of water, a diving start time, and allowable diving time of non-decompression. Each item of the diving information is displayed on a liquid crystal display of the digital camera together with an image currently photographed.

### BACKGROUND OF THE INVENTION

1. Field of the Invention

The present invention relates to a digital camera having a display on which diving information is indicated together with an image currently photographed in diving.

2. Description of the Related Art

In a widely used digital camera, an image is taken by an image sensor of a CCD image sensor and so forth. The taken image is converted into image data to be stored in a storage medium of a memory card and so forth. This kind of the digital camera is usually provided with a liquid crystal display (hereinafter LCD) constituting an electronic viewfinder on which a subject image taken through a taking lens is displayed in real time. The LCD is also used for a playback of the image and so forth.

Meanwhile, a waterproof case (underwater housing) is sold for enabling to perform underwater photographing with the digital camera in scuba diving. This waterproof case contains the digital camera water-tightly, and is adapted to be capable of operating a release button and so forth of the digital camera from the outside of the waterproof case.

In scuba diving using compressed air, nitrogen absorbed into the body is excreted by stopping decompression for the purpose of avoiding decompression sickness. However, in general scuba diving called sports diving or leisure diving, non-decompression diving is performed in order to increase the security of diving. In the non-decompression diving, a diving depth and a diving time are controlled so as not to require the stoppage of decompression.

In order to control the diving depth and the diving time, are used a console gauge, a diving watch and so forth in which a water depth gauge, a residual pressure gauge, a compass, etc. are incorporated. In recent years, a diving computer is widely used. The diving computer detects a water pressure by a pressure sensor to calculate a nitrogen amount accumulated in a diver's body. From the calculated nitrogen amount, an allowable diving time under the non-decompression condition is calculated to be displayed. In general, the diving computer displays the diving time, which is a time passing from the start of diving, and the diving depth as well besides the non-decompression diving time.

A certain diving computer is incorporated in the console gauge together with the residual pressure gauge and the compass. Another diving computer is worn near a wrist such as a watch. In the meantime, it is known that the non-decompression diving time, the diving time and the diving depth are easily confirmed by fixing the diving computer to an arm or the like of a lighting unit attached to an underwater camera (Japanese Patent Laid-Open Publication No. 7-215283).

When performing underwater photographing, it is likely to neglect and forget confirming the non-decompression diving time, the diving time and the diving depth, which are displayed by means of the console gauge and the diving computer, upon concentration on photographing. Thus, there arises a problem in that a diver sometimes falls into serious situations wherein a stoppage of decompression must be carried out and the allowable diving depth is carelessly exceeded.

### SUMMARY OF THE INVENTION

In view of the foregoing, it is a primary object of the present invention to provide a digital camera improved for securing safety at the time of underwater photographing.

It is a second object of the present invention to provide a digital camera improved such that diving information is prevented from being missed.

In order to achieve the above and other objects, the digital camera according to the present invention comprises a sensing member and a display controlling member. The sensing member includes at least a pressure sensor for measuring a water pressure. The display controlling member controls a display of the digital camera so as to indicate diving information, which is obtained from the sensing member, together with an image currently photographed in diving. It is preferable that the digital camera further comprises a recording member for recording the diving information in a storage medium together with the photographed image.

In another embodiment, the digital camera is contained in a waterproof case when underwater photographing is performed. The waterproof case has a sensing member including at least a pressure sensor for measuring a water pressure. The digital camera comprises an input portion through which diving information obtained from the sensing member of the waterproof case is inputted therein. The digital camera further comprises a display controlling member, which controls a display of the digital camera so as to indicate the diving information together with an image currently photographed in diving.

It is preferable that the digital camera comprises an alarm unit, which generates a warning sound when the diving information obtained from the sensing member satisfies a predetermined condition.

According to the digital camera of the present invention, the diving information is prevented from being missed. Further, in the case that the diving information is recorded in the storage medium together with the photographed image, the diving information may be utilized when classifying the images.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a front perspective view showing a digital camera according to the present invention;

FIG. 2 is a rear perspective view showing the digital camera;

FIG. 3 is a block diagram showing a structure of the digital camera;

FIG. 4 is an explanatory illustration showing a display state of an LCD;

FIG. 5 is a block diagram showing an embodiment in which diving profile is recorded in a memory card;

FIG. 6 is a flow chart showing an embodiment in which photographing is prohibited when a diving state becomes dangerous;

FIG. 7 is a perspective view showing a digital camera and a waterproof case provided with sensors;

FIG. 8 is a block diagram showing an electrical structure of the embodiment shown in FIG. 7;

FIG. 9 is a block diagram showing an embodiment in which information is received from a diving computer; and

FIG. 10 is a flow chart showing an embodiment in which diving information is recorded as an image file of Exif standard together with image data.

### DETAILED DESCRIPTION OF THE PREFERRED EMBODIMENT(S)

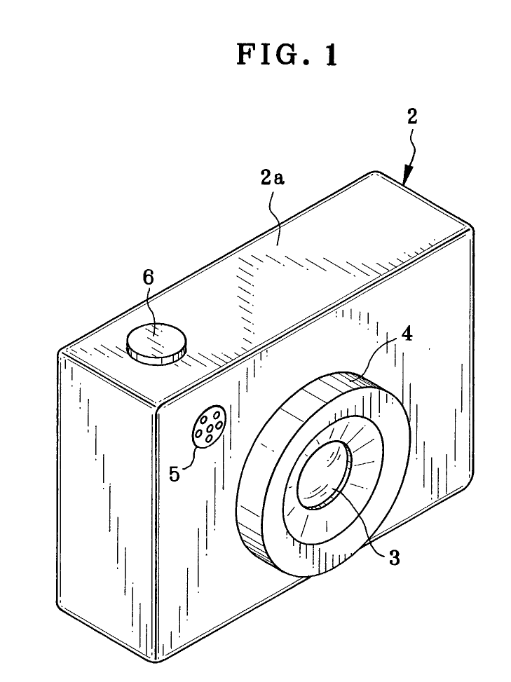

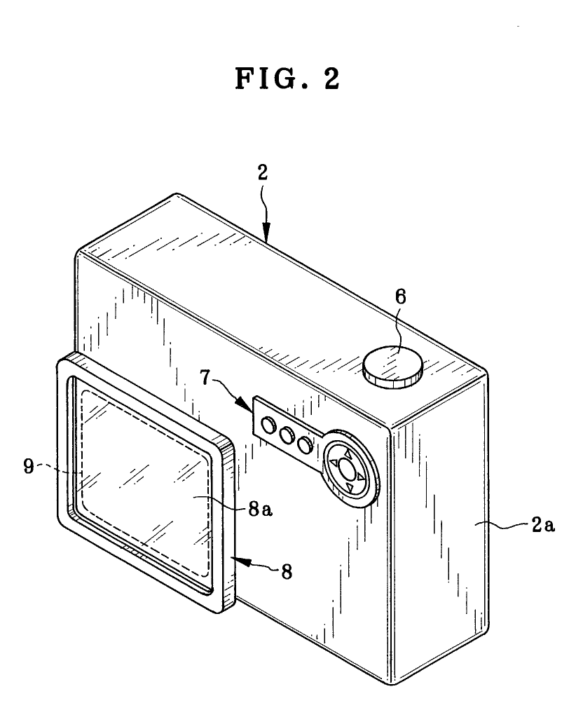

FIG. 1 shows a front perspective view of a digital camera 2 according to the present invention, and FIG. 2 shows a rear perspective view thereof. A camera body 2a of the digital camera 2 has water proofing property so as to be capable of performing underwater photographing in scuba diving. The front of the camera body 2a is provided with a lens barrel 4 holding a taking lens 3, and a sensor window 5. Further, the top of the camera body 2a is provided with a release button 6, and the back thereof is provided with an operational portion 7 and a viewfinder display window 8.

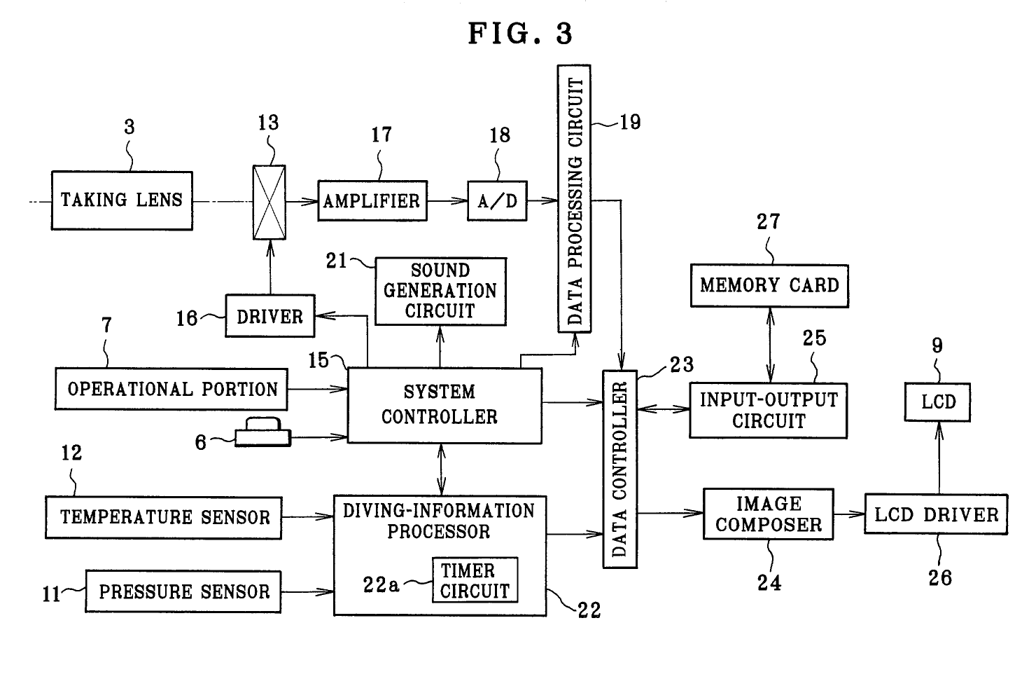

A transparent glass plate 8a is fitted to the viewfinder display window 8. Through the transparent glass plate 8a, it is possible to watch a liquid-crystal display panel (hereinafter LCD) disposed behind the glass plate 8a. A pressure sensor 11 and a temperature sensor 12 (see FIG. 3) constituting a sensing section are provided behind the sensor window 5. Water pressure (diving depth) and water temperature in diving are measured by the respective sensors 11 and 12.

By manipulating the operational portion 7, it is possible to turn on and off a power supply of the digital camera 2, further, it is also possible to switch a photographing mode and a playback mode. In addition, an image to be reproduced is selected with the operational portion 7, and data of the image can be erased therewith. Furthermore, by manipulating the operational portion 7, it is possible to optionally input a diving time to be set. When the set diving time is inputted, the digital camera 2 generates a warning sound after the set diving time has passed from the start of diving.

The LCD 9 constitutes the so-called electronic viewfinder displaying a subject image photographed through the taking lens 3, namely displaying an image in photographing, in real time. The LCD 9 is also used for reproducing the photographed image. Under a diving mode, the LCD 9 displays diving information of the depth of water and so forth. Incidentally, the digital camera 2 is operated under either of the diving mode and an anti-diving mode. The diving information is displayed under the diving mode and is not displayed under the anti-diving mode. These modes are automatically switched in accordance with the measured water pressure.

The bottom of the camera body 2 is provided with an openable lid for a memory slot (not shown). By opening this lid, it is possible to insert and remove a memory card. Upon depressing the release button 6, an image of one frame in photographing is taken by a CCD image sensor 13 (see FIG. 3) disposed behind the taking lens 3. Then, an obtained image data is saved in the loaded memory card. When photographing is performed under the diving mode, water-depth data and water-temperature data in photographing are saved in the memory card together with the image data.

FIG. 3 shows an electrical structure of the digital camera 2. A system controller 15 controls each section of the digital camera 2 in response to operation signals inputted from both of the release button 6 and the operational portion 7. The CCD image sensor 13 is disposed behind the taking lens 3 and is driven by a driver 16 to convert an optical subject image into an electric photograph signal to be outputted.

On a light receiving surface of the CCD image sensor 13, micro color filters of R, G and B are arranged in matrix. The photograph signal serially outputted every color is amplified by an amplifier 17 up to an appropriate level. After that, the photograph signal is digitally converted by an A-D converter 18 to produce image data of each color of red, green and blue. Incidentally, the taking lens 3 is focused by an AF mechanism, which is not shown, on the basis of contrast of the photographed image, for example. The contrast is detected from the photograph signal.

A data processing circuit 19 executes white-balance adjustment, gamma correction and so forth for the image data outputted from the A-D converter 18. In addition, the data processing circuit 19 executes image processing for the respective image data of red, green and blue to produce one-frame image data regarding the respective colors.

A sound generation circuit 21 is constituted of a speaker, a driving circuit thereof, and so forth to generate operational sounds, which correspond to the respective operations of the release button 6 and the operational portion 7, under the control of the system controller 15. The sound generation circuit 21 also works as an alarm device to generate a warning sound when the diving time measured by a diving-information processor 22, which is described later, has reached the set diving time inputted with the operational portion 7.

As described above, the pressure sensor 11 and the temperature sensor 12 are disposed behind the sensor window 5. The pressure sensor 11 is for detecting the water pressure and the diving depth (the depth of water). The pressure sensor 11 outputs a pressure signal in accordance with the surrounding pressure of the digital camera 2, namely in accordance with the water pressure thereof. The temperature sensor 12 detects the water temperature and outputs a temperature signal in accordance with the surrounding temperature of the digital camera 2.

The diving-information processor 22 detects the water pressure on the basis of the pressure signal outputted from the pressure sensor 11. From the detected water pressure, the diving depth is derived. The diving-information processor 22 further detects the water temperature on the basis of the temperature signal outputted from the temperature sensor 12. Under the anti-diving mode, the diving-information processor 22 detects only the water pressure at proper intervals. When the diving depth obtained from this detection exceeds a predetermined level, which is 1.5 m for instance, a start of diving is judged so that the anti-diving mode is switched to the diving mode.

The diving-information processor 22 includes a timer circuit 22a for clocking the diving time progressing from the start of diving. The timer circuit 22a is reset and started at the moment that the anti-diving mode has been changed to the diving mode.

The diving-information processor 22 clocks the diving time with the timer circuit 22a under the diving mode. In addition, the diving-information processor 22 detects the water pressure and the water temperature at fixed intervals, for instance every second. From the detection result, are derived the diving depth, the water temperature, the maximum depth of water (maximum diving depth), and non-decompression diving time as the diving information. When the diving depth becomes shallow rather than the predetermined level under the diving mode, a finish of diving is judged so that the diving mode is changed to the anti-diving mode. Incidentally, as well known, the non-decompression diving time means a limited stay time of the respective depths, which is capable of rising from the current depth to the surface without causing the decompression sickness and without stopping the decompression.

The set diving time inputted with the operational portion 7 is taken into the diving-information processor 22 by the system controller 15. In the case the set diving time is prescribed under the diving mode, the diving-information processor 22 activates the sound generation circuit 21 via the system controller 15 to generates the warning sound when the diving time clocked by the timer circuit 22a has reached the set diving time.

Under the instruction of the system controller 15, a data controller 23 controls input-output of data among the data processing circuit 19, the diving-information processor 22, an image composer 24, and an input-output circuit 25. In the photographing mode, the image data from the data processing circuit 19 is transmitted to the image composer 24 via the data controller 23. Successively, the image data is transmitted from the image composer 24 to an LCD driver 26. Owing to this, the subject image in photographing is displayed on the LCD 9 as a dynamic image.

When the diving mode is set under the photographing mode, each item of the diving information from the diving-information processor 22 is transmitted to the image composer 24 via the data controller 23. The image composer 24 being as a display controlling member produces character-image data on the basis of each item of the diving information. By using the character-image data and the image data of the data processing circuit 19, is produced composed image data in which each item of the diving information is synthesized on the subject image currently photographed. The composed image data is transmitted to the LCD driver 26 so that the LCD 9 displays a composed image in which each item of the diving information is synthesized on the subject image. Incidentally, as to the function of the image composer 24, it is possible to utilize a conventional function provided for displaying an image on which operational guidance and so forth of the digital camera are superposed.

The input-output circuit 25 reads and writes data of a memory card 27 loaded in the memory slot. Upon depressing the release button 6 under the photographing mode, one-frame image data outputted from the data processing circuit 19 at that time is transmitted to the input-output circuit 25 via the data controller 23. The input-output circuit 25 writes the transmitted image data in the memory card 27. While the one-frame image data is written, the diving information of the current water temperature and the current depth of water are transmitted to the input-output circuit 25 via the data controller 23 under the diving mode. Thus, the diving information of the water temperature and the depth of water are saved in the memory card 27 so as to correspond to the image data. Incidentally, the pressure sensor 11 and the temperature sensor 12 may be activated during not only diving but also the other occasions to display an altitude and an air temperature on the LCD 9. The altitude and the air temperature may be recorded together with the image data.

Under the playback mode, the image data selected with the operational portion 7 is read from the memory card 27 by the input-output circuit 25. The selected image data is transmitted to the data controller 23, the image composer 24, and the LCD driver 26. Owing to this, the image saved in the memory card 27 is displayed on the LCD 9 as a static image. Incidentally, when the playback mode is set under the diving mode, the static image on which each item of the diving information is synthesized is displayed on the LCD 9 similarly to the photographing mode under the diving mode.

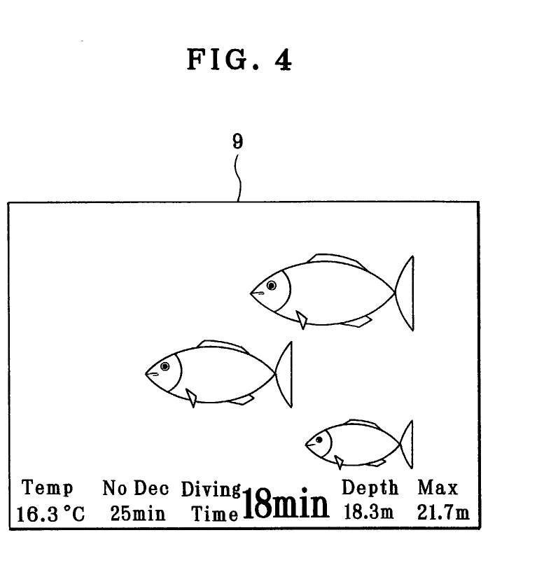

FIG. 4 shows a display state of the LCD 9 under the diving mode. The whole LCD 9 displays either of the subject image in photographing and the playback image. A part of the LCD 9 (lower portion in FIG. 4) displays the water temperature (Temp), the non-decompression diving time (NoDec), the diving time (Diving Time), the current diving depth (Depth), the maximum depth of water (Max), which are respectively synthesized.

In this embodiment, the diving information is always displayed together with either of the photographing image and the playback image. However, the diving information may be displayed at predetermined intervals, for example. Alternatively, the diving information may be displayed when the specific button of the operational portion 7 and so forth is depressed. Further, the diving information may disappear so as not to disturb framing only when the specific button is depressed. In the cases that the diving information is displayed at the time of operating the specific button, and in the case that the diving information disappears at the time of operating the specific button, it is preferable that the diving information is compulsorily displayed to prevent a dangerous situation when the diving depth approaches a predetermined limit depth, for example.

Successively, an operation of the above structure is described below. When underwater photographing is performed, diving is started after turning on the power supply of the digital camera 2 by using the operational button 7. The power supply may be automatically turned on when reaching an appropriate depth in diving.

For instance, when the photographing mode is set, the image data of the subject image taken by the CCD image sensor 13 is continuously transmitted to the data processing circuit 19. When the anti-diving mode is set, namely when the diving depth does not reach the predetermined level, the image data processed by the data processing circuit 19 is transmitted to the LCD driver 26 via the data controller 23 and the image composer 24. However, the diving information is not synthesized in the image composer 24 so that the LCD 9 displays only the subject image currently taken by the CCD image sensor 13.

After the start of diving, the diving-information processor 22 detects the diving depth on the basis of the pressure signal outputted from the pressure sensor 11. When it is judged that the diving depth reaches the predetermined level, the current anti-diving mode is switched to the diving mode. Upon this, the diving-information processor 22 resets a value of the timer circuit 22a to zero, and starts to clock the diving time. Moreover, the water temperature and the water pressure are periodically measured by the diving-information processor 22. Whenever the periodic measurement is executed, the water temperature, the diving depth, the maximum depth of water, and the non-decompression diving time are respectively derived. Each item of the diving information is transmitted to the image composer 24 via the data controller 23.

When the diving mode is set, the image data of the subject image in photographing is inputted into the image composer 24 together with the diving information of the diving-information processor 22. On the basis of the image data and the diving information, the image composer 24 produces the composed image data in which the diving time, the water temperature, the diving depth, the maximum depth of water, and the non-decompression diving time are synthesized on the subject image currently taken. The LCD driver 26 actuates the LCD 9 in accordance with the composed image data.

Thus, such as shown in FIG. 4, the LCD 9 displays the currently-taken subject image on which the current diving time, the current water temperature, the current diving depth, the maximum depth of water, and the allowable non-decompression diving time are synthesized. The diving information displayed in this way is momentarily updated in accordance with the passage of time and the changes of the diving depth and the water temperature.

When taking a picture, a photographer decides framing, watching the subject image displayed on the LCD 9 together with the diving information. And then, the photographer depresses the release button 6. Upon depression of the release button 6, the one-frame image data currently taken is transmitted to the input-output circuit 25 via the data controller 23 under the instruction of the system controller 15. The transmitted image data is written in the memory card 27. Meanwhile, the diving information of the diving depth and the water temperature obtained in photographing are transmitted from the diving-information processor 22 to the input-output circuit 25 via the data controller 23. The transmitted diving information is written in the memory card 27 so as to correspond to the image data.

In the diving mode, the diving depth and the water temperature are recorded together with the image data. Thus, the diving depth and the water temperature may be utilized after diving for the purpose of classifying the images, and may be also utilized as material. Incidentally, a photographic date and a photographic time may be recorded so as to correspond to the image data.

When the photographed image is confirmed, the playback mode is selected. Upon setting the playback mode, the image data selected with the operational portion 7 is read from the memory card 27. The read image data is transmitted to the image composer 24 via the data controller 23. In the case the playback mode is selected under the diving mode, each item of the diving information from the diving-information processor 22 is transmitted to the image composer 24 via the data controller 23, similarly to the photographing mode under the diving mode. Owing to this, the LCD 9 displays the composed image including the diving information, similarly to the photographing mode. By the way, when the unnecessary image data is deleted, the operational portion 7 is operated to instruct the deletion in a state that the image to be deleted is displayed on the LCD 9 under the playback mode.

A diver being as the photographer can confirm the various items of the diving information, which are momentarily updated, watching the subject image in photographing or the image stored in the memory card 27, which are displayed on the LCD 9, through the viewfinder display window 8. In virtue of this, even if the photographer is absorbed in taking a picture and in playing back the photographed image, it is prevented to miss out the diving information so that diving may be safely practiced.

When the set diving time is inputted with the operational portion 7, the diving-information processor 22 compares the set diving time with the diving time, which is clocked by the timer circuit 22a, from the moment of changing to the diving mode. When the clocked diving time becomes equal to the set diving time, the diving-information processor 22 simultaneously activates the sound generation circuit 21 via the system controller 15 to generate the warning sound. Accordingly, by inputting the planned diving time to be spent from the diving start to the surfacing start, it is possible to know the start timing of surfacing even if attention is not paid to the diving information displayed on the LCD 9. Thus, the security of diving may be improved.

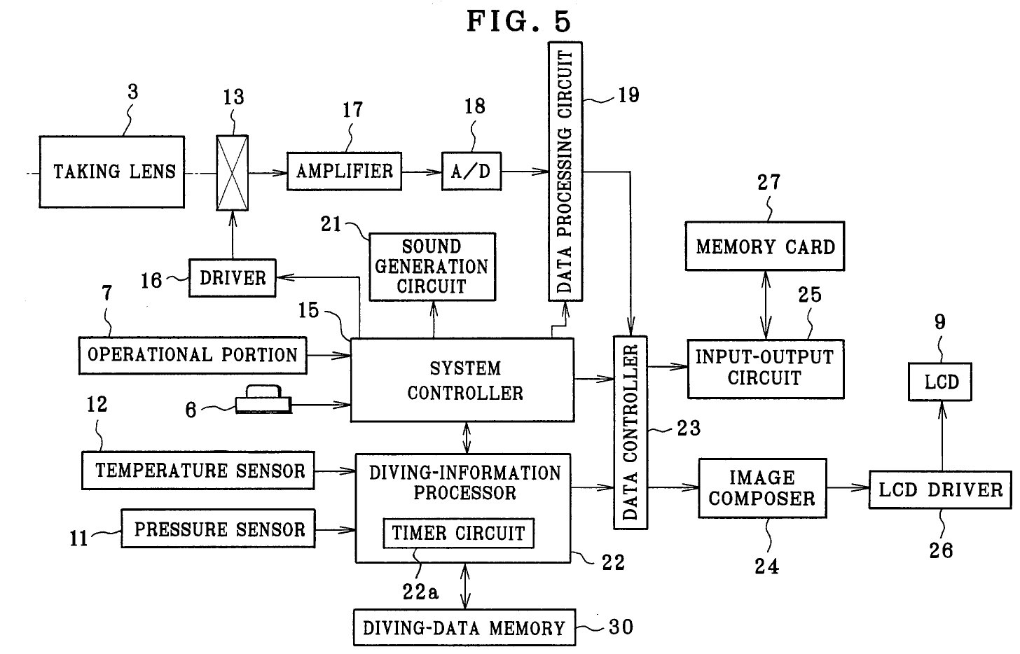

FIG. 5 shows a second embodiment in which a memory card is capable of saving a diving profile. This embodiment is identical with the above embodiment except the following. A similar component is denoted by the same reference numeral, and detailed description thereof is abbreviated.

A diving-data memory 30 is connected to the diving-information processor 22. In the diving-data memory 30, diving depths measured at predetermined intervals under the diving mode are recorded one by one in time series. By recording the diving depths, the diving profile is drawn up in the diving-data memory 30. The diving profile means a change of the diving depth caused by passage of time during one-time diving. When recording to the memory card 27 is instructed with the operational portion 7 after diving, the diving profile recorded in the diving-data memory 30 is read by the diving-information processor 22 first. The read diving profile is transmitted to the input-output circuit 25 via the data controller 23, and is recorded in the memory card 27 as a single file.

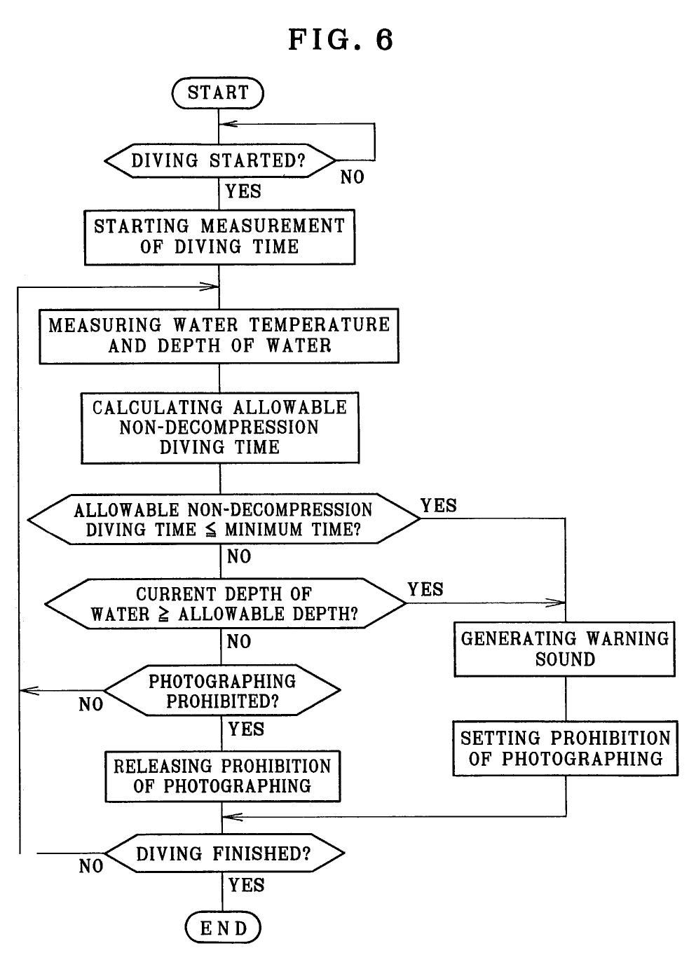

FIG. 6 shows a third embodiment in which photographing is prohibited when the diving situation becomes dangerous. This embodiment is identical with the first embodiment except the following. A similar component is denoted by the same reference numeral, and detailed description thereof is abbreviated.

In the third embodiment, a minimum diving time of non-decompression and an allowable diving depth are predetermined in the diving-information processor 22. When the clocked diving time of non-decompression reaches the minimum diving time, and when the diving depth detected by the pressure sensor 11 exceeds the allowable diving depth, the diving-information processor 22 sends an instruction for prohibition of photographing to the system controller 15. Upon receiving this instruction, the system controller 15 generates the warning sound with the sound generation circuit 21 being as the alarm device. After that, a photographing prohibition state is set so as to prohibit taking a picture by depressing the release button 6. Incidentally, it is preferable to prevent the LCD 9 from displaying the image when photographing is prohibited. With respect to the diving information, it is preferable to continue the display thereof.

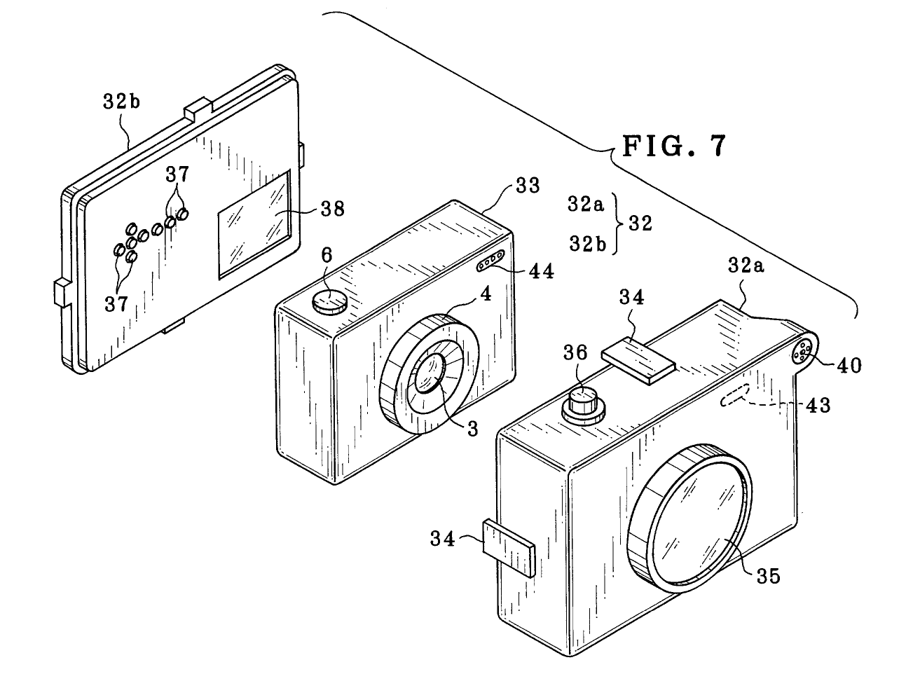

FIG. 7 shows an embodiment of a photographing system in which underwater photographing is performed with a digital camera contained in a waterproof case. This embodiment is identical with the first embodiment except the following. A similar component is denoted by the same reference numeral, and detailed description thereof is abbreviated.

An underwater photographing system of this embodiment includes a waterproof case 32 and a digital camera 33 of a non-waterproof type. By containing the digital camera 33 in the waterproof case 32, it is possible to perform underwater photographing. The waterproof case 32 comprises a housing body 32a and a lid member 32b. The back of the housing body 32a is closed with the lid member 32b in a state that the housing body 32a contains the digital camera 33. The lid member 32b is attached to the housing body 32a by a buckle 34 to water-tightly close the back thereof.

A portion of the housing body 32a facing the taking lens 3 of the digital camera 33 is provided with a transparent photographic window 35 through which a picture is taken. The housing body 32a is provided with an interlock button 36 for operating the release button 6 of the digital camera 33 from the outside of the waterproof case 32. Moreover, the lid member 32b is provided with interlock buttons 37 for operating the operational portion 7 of the digital camera 33 from the outside of the waterproof case 32. A portion of the lid member 32b facing the LCD 9 of the digital camera 33 is provided with a transparent viewfinder window 38 through which it is possible to watch the image and so forth displayed on the LCD 9.

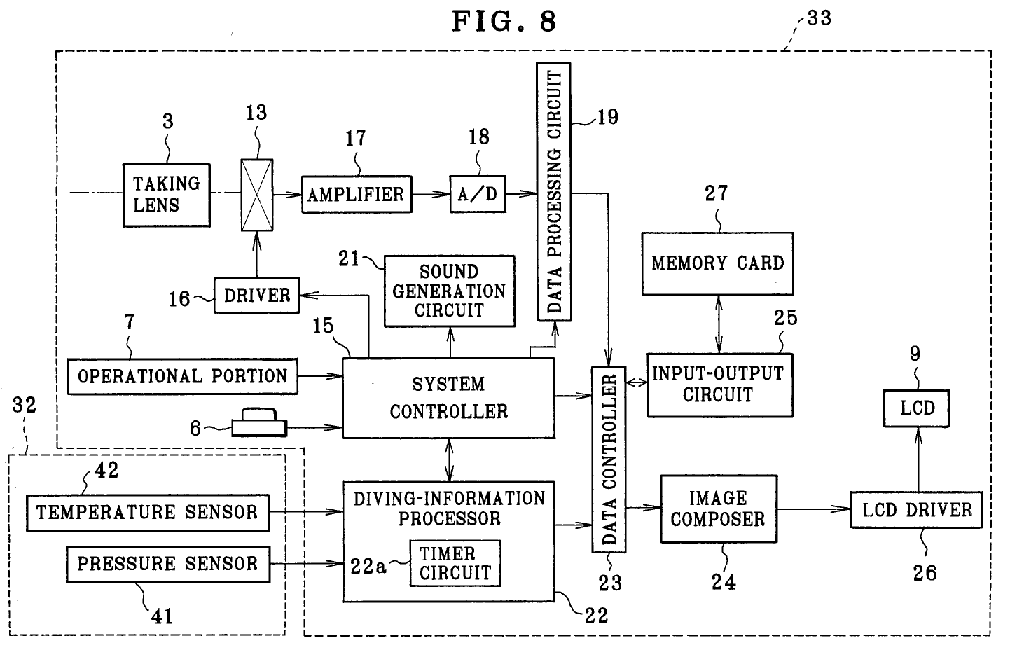

A right-upper portion of the housing body 32a is provided with a sensor window 40 behind which a pressure sensor 41 and a temperature sensor 42 (see FIG. 8) are disposed. The pressure sensor 41 and the temperature sensor 42 are connected to a connector 43 provided inside the housing body 32a. Upon containing the digital camera 33 in the waterproof case 32, the connector 43 of the waterproof case 32 is joined to a connector 44 provided outside the digital camera 33. Owing to this, an internal circuit of the digital camera 33 is electrically connected to the pressure sensor 41 and the temperature sensor 42 of the waterproof case 32. In this embodiment, the connector 44 is an input member through which information from the sensor is inputted. However, the waterproof case 32 and the digital camera 33 may be connected by utilizing a ray and a radio wave.

FIG. 8 shows an electrical structure of the waterproof case 32 and the digital camera 33. As shown in FIG. 8, the pressure sensor 41 and the temperature sensor 42 of the waterproof case 32 respectively transmit a pressure signal and a temperature signal to the diving-information processor 22 built in the digital camera 33.

In this underwater photographing system, working and effect caused by containing the digital camera 33 in the waterproof case 32 are similar to the first embodiment. To be sure, such as shown in FIGS. 5 and 6, the diving profile may be recorded, further, photographing may be prohibited in accordance with the diving depth and the non-decompression diving time. In this embodiment, the diving-information processor 22 is built in the digital camera 33, but may be provided at the side of the waterproof case 32.

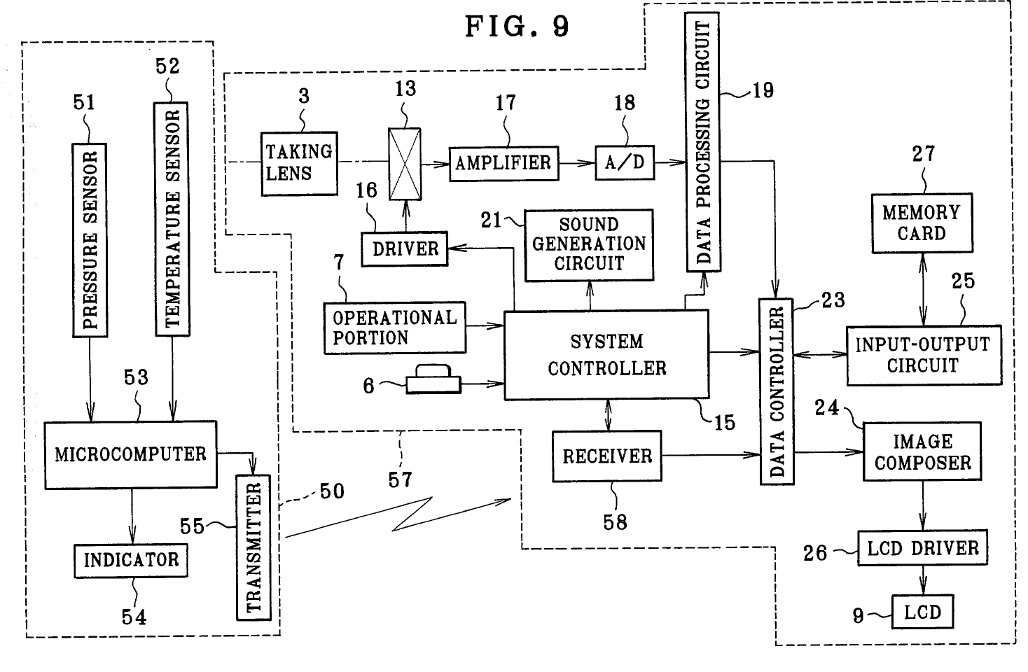

FIG. 9 shows an embodiment in which information is obtained from a diving computer 50 instead of providing the pressure sensor and the temperature sensor in the digital camera or the waterproof case. The diving computer 50 comprises a pressure sensor 51, a temperature sensor 52, a microcomputer 53, an indicator 54, and a transmitter 55. The structure of the diving computer 50 is identical with that of a conventional diving computer except the transmitter 55. Concretely, the microcomputer 53 executes operation processing and so forth on the basis of detection results of the pressure sensor 51 and the temperature sensor 52 to obtain the diving information of the diving time, the diving depth, the water temperature, the non-decompression diving time, the maximum depth of water and so forth. The obtained diving information is displayed on the indicator 54 constituted of an LCD and so forth. The transmitter 55 sends the diving information, which is obtained from the microcomputer 53, by using the radio wave of an appropriate frequency.

A digital camera 57 is provided with a receiver 58 which receives the radio wave sent from the transmitter 55 of the diving computer 50 to obtain the diving information. The obtained diving information is outputted to the data controller 23. The digital camera 57 in itself may have a waterproof function similarly to the first embodiment. Alternatively, the digital camera 57 may be contained in the waterproof case such as shown in FIG. 7 to perform underwater photographing. In the case the waterproof case contains the digital camera, the waterproof case may be provided with a receiver to transmit the diving information, which is obtained thereby, to the digital camera. Further, instead of using the radio wave, a supersonic wave may be used to transmit the diving information from the diving computer to the digital camera.

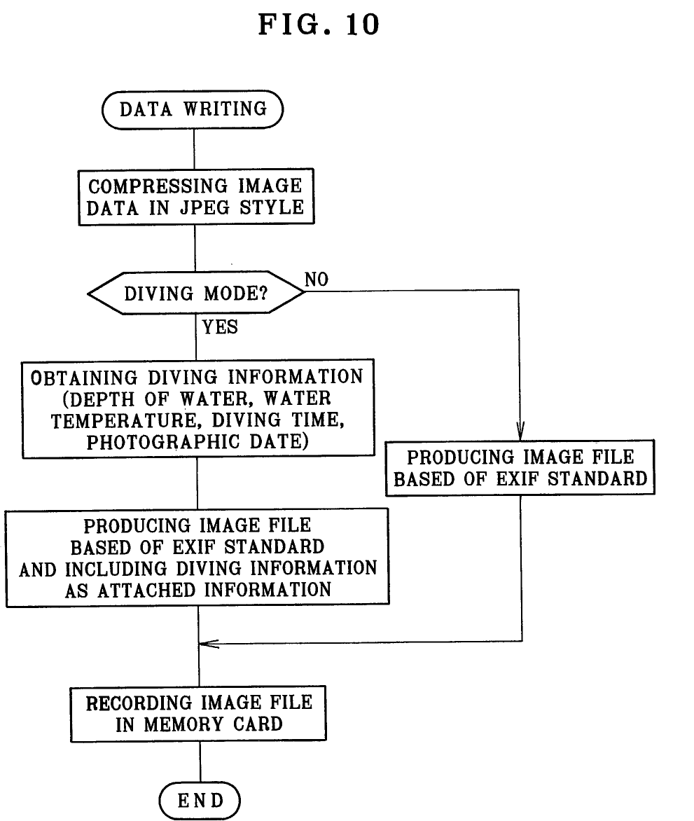

FIG. 10 shows an embodiment in which the image data is recorded as an image file based on Exif standard, and the diving information is recorded as attached information of the image file. Incidentally, this embodiment is identical with the first embodiment except the following. A similar component is denoted by the same reference numeral, and detailed description thereof is abbreviated.

Upon depressing the release button 6, the image data of one frame currently photographed is compressed in JPEG style by the data processing circuit 19 and is kept. Under the diving mode, the system controller 15 derives, from the diving-information processor 22, the current water temperature, the current depth of water, and the diving time clocked by the timer circuit 22a, which are transmitted to the data processing circuit 19 as the diving information. Meanwhile, the system controller 15 recognizes the present date, or the photographic date, which is also transmitted to the data processing circuit 19 as the diving information.

Upon inputting the diving information, the data processing circuit 19 produces a single image file based on the Exif standard. In this image file, the compressed image data is included as main image data, and the diving information is included as attached information. Data of the produced image file is transmitted to the input-output circuit 25 via the data controller 23. The input-output circuit 25 writes the inputted data of the image file into the memory card 27. In this way, the image file including the diving information and based on the Exif standard is recorded in the memory card 27.

As well known, according to the Exif standard, it is possible to record the image data and the attached information thereof in the sole image file. In the Exif standard, the image data is converted into the JPEG compression data. Besides this, it is possible to convert the image file into YCbCr non-compression data and RGB non-compression data based on Tiff standard. Incidentally, in camera-file-system standard (DCF), the image file is recorded in a style based on the Exif standard, but the image data is necessary to be converted into JPEG compression data.

As to the attached information, are always recorded certain information of Exif version, characteristics of the image data, resolution of the image, and so forth. In addition, it is possible to record the other information, for instance, date information of “Date Time Original” (tag number:36867) representing the photographic date, photographic-condition information of an f-number, a shutter speed, etc., user information, and a thumbnail image. As the user information, are prepared tags of “Maker Note” (tag number:37500) and “User Comment”. A camera manufacturer can freely enters information into the “Maker Note”. The attached information recorded in the image file may be utilized by using application software meeting the Exif standard.

In this embodiment, the water temperature, the depth of water and the diving time are recorded in the image file as “Maker Note”, and the photographic date is recorded in the image file as “Date Time Original”. Concretely, application marker segment 1 (APP1) is inserted just after an SOI marker representing the beginning of the JPEG-compression-data file. In the application marker segment 1, the attached information including the above-noted “Maker Note” and “Date Time Original” are recorded according to the TIFF standard.

Under the anti-diving mode, are not recorded the water temperature, the depth of water, and the diving time as the attached information, although the image data obtained by photographing is included in the image file based on the Exif standard. It is needless to say that an air temperature, an altitude, and an air pressure of a photographic point may be recorded instead of the water temperature and the depth of water.

According to the above structure, both of the image data and the diving information are recorded in the image file based on the Exif standard. Thus, the diving information may be easily obtained by using an application software meeting the Exif standard, for example. Of course, the diving information may be also obtained by various apparatuses meeting the Exif standard. The Exif standard is widely used so that the diving information is easily utilized.

In the above embodiments, the diving information includes the water temperature, the non-decompression diving time, the diving time, the current depth of water, the maximum depth of water, and the diving profile. However, it is possible to properly determine the items to be included in the diving information.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A digital camera having display means for displaying one of an image in photographing and a photographed image, comprising:
a sensor section including at least a pressure sensor for measuring a water pressure; and
display controlling means for displaying diving information, which is based on information obtained from said sensor section, on said display means.

2. A digital camera according to claim 1, further comprising:
record means for recording the photographed image in a storage medium.

3. A digital camera according to claim 2, wherein said record means records said diving information in said storage medium together with the photographed image.

4. A digital camera according to claim 2, wherein said diving information includes a depth of water.

5. A digital camera according to claim 4, further comprising:
warning means for generating a warning sound when said diving information satisfies a predetermined condition.

6. A digital camera according to claim 5, wherein said sensor section further includes a temperature sensor for measuring a water temperature, and said diving information further includes the measured water temperature.

7. A digital camera recording a photographed image in a storage medium, comprising:
a sensor section including at least a pressure sensor for measuring a water pressure; and
record means for recording diving information, which is based on information obtained from said sensor section, in said storage medium together with the photographed image.

8. A digital camera according to claim 7, wherein said record means records the photographed image in said storage medium as an image file based on Exif standard, and records said diving information in said image file as attached information.

9. A digital camera according to claim 8, wherein said storage medium is a memory card removably loaded in said digital camera.

10. A digital camera according to claim 7, further comprising:
warning means for generating a warning sound when said diving information satisfies a predetermined condition.

11. A digital camera having display means for displaying one of an image in photographing and a photographed image, said digital camera being used together with an external member, which has a sensor section including at least a pressure sensor for measuring a water pressure, when underwater photographing is performed, said digital camera comprising:
input means through which information from said sensor section of said external member is inputted; and
display controlling means for displaying diving information, which is based on the information inputted through said input means, on said display means.

12. A digital camera according to claim 11, further comprising:
record means for recording the photographed image in a storage medium.

13. A digital camera according to claim 12, wherein said record means records said diving information in said storage medium together with the photographed image.

14. A digital camera according to claim 11, wherein said external member is a waterproof case water-tightly containing said digital camera so as to enable underwater photographing.

15. A digital camera according to claim 14, wherein said input means is a first connector provided on a front face of said digital camera, and is joined to a second connector provided on said waterproof case.

16. A digital camera according to claim 14, further comprising:
warning means for generating a warning sound when said diving information satisfies a predetermined condition.

17. A digital camera according to claim 14, wherein said sensor section further includes a temperature sensor for measuring a water temperature, and said diving information includes the measured water temperature.

18. A digital camera recording a photographed image in a storage medium, said digital camera being used together with an external member, which has a sensor section including at least a pressure sensor for measuring a water pressure, when underwater photographing is performed, said digital camera comprising:
input means through which information from said sensor section of said external member is inputted; and
record means for recording diving information, which is based on the information inputted through said input means, in said storage medium together with the photographed image.

19. A digital camera according to claim 18, wherein said external member is a waterproof case water-tightly containing said digital camera so as to enable underwater photographing.

20. A digital camera according to claim 19, wherein said input means is a first connector provided on a front face of said digital camera, and is joined to a second connector provided on said waterproof case.

21. A digital camera according to claim 19, further comprising:
warning means for generating a warning sound when said diving information satisfies a predetermined condition.

22. A digital camera according to claim 19, wherein said record means records the photographed image in said storage medium as an image file based on Exif standard, and records said diving information in said image file as attached information.

23. A digital camera according to claim 22, wherein said storage medium is a memory card removably loaded in said digital camera.

24. A digital camera having display means for displaying one of an image in photographing and a photographed image, said digital camera being used together with an external member, which has a sensor section including at least a pressure sensor for measuring a water pressure, when underwater photographing is performed, said digital camera comprising:
input mean through which diving information is inputted, said diving information being produced in said external member on the basis of information obtained from said sensor section; and
display controlling means for displaying said diving information, which has been inputted through said input means, on said display means.

25. A digital camera according to claim 24, further comprising:
record means for recording the photographed image in a storage medium.

26. A digital camera according to claim 25, wherein said record means records said diving information in said storage medium together with the photographed image.

27. A digital camera according to claim 24, wherein said external member is a diving computer for displaying said diving information, and said input means is a receiver for receiving said diving information sent from said diving computer in a wireless manner.

28. A digital camera according to claim 27, further comprising:
warning means for generating a warning sound when said diving information satisfies a predetermined condition.

29. A digital camera according to claim 27, wherein said sensor section further includes a temperature sensor for measuring a water temperature, and said diving information includes the measured water temperature.

30. A digital camera recording a photographed image in a storage medium, said digital camera being used together with an external member, which has a sensor section including at least a pressure sensor for measuring a water pressure, when underwater photographing is performed, said digital camera comprising:
input mean through which diving information is inputted, said diving information being produced in said external member on the basis of information obtained from said sensor section; and
record means for recording said diving information, which has been inputted through said input means, in said storage medium together with the photographed image.

31. A digital camera according to claim 30, wherein said external member is a diving computer for displaying said diving information, and said input means is a receiver for receiving said diving information sent from said diving computer in a wireless manner.

32. A digital camera according to claim 31, further comprising:
warning means for generating a warning sound when said diving information satisfies a predetermined condition.

33. A digital camera according to claim 31, wherein said record means records the photographed image in said storage medium as an image file based on Exif standard, and records said diving information in said image file as attached information.

34. A digital camera according to claim 32, wherein said storage medium is a memory card removably loaded in said digital camera.
